(19) United States
(12) Patent Application Publication
(10) Pub. No.: US 2007/0286104 A1
(43) Pub. Date: Dec. 13, 2007

(54) Method and System for Data Interworking and Inter-Network Communication Conversion Device and Interworking Function Mode

(75) Inventor: Hu Li, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzen (CN)

(21) Appl. No.: 11/659,784

(22) PCT Filed: Jun. 29, 2006
(86) PCT No.: PCT/CN06/01498

§ 371 Date: Jul. 30, 2007

(30) Foreign Application Priority Data
Jun. 29, 2005 (CN) 200510035657.2

(51) Int. Cl. H04B 7/00

(52) U.S. Cl. 370/310.1

(57) ABSTRACT

The method and system for data interworking between networks in accordance with the embodiments of the present invention forward a data packet from a wireless network to an IWF module via an ATM interface. The IWF module extracts an IWF user-plane payload from the data packet and modulates the IWF user-plane payload to form a code stream and sends the code stream to a fixed communication network. In another method and system for data interworking between networks in accordance with the embodiments of the present invention, the IWF module processes including demodulating the data from the inter-network communication conversion device, extracts the IWF user-plane payload from the demodulated data, converts the extracted IWF user-plane payload to a data packet supporting the ATM protocol and sends the converted data packet to the wireless network via the ATM interface. As above, the embodiments of the present invention can decrease communication delay, thereby improving user's satisfaction.

### FIELD OF THE TECHNOLOGY

The present invention relates to communication technologies, and more specifically, to methods and systems for data interworking as well as an inter-network communication conversion device and an Interworking Function (IWF) module.

### BACKGROUND OF THE INVENTION

In recent years, in order to support normal communications between a wireless network and a non-wireless network, an inter-network communication conversion device connected between the wireless network and the non-wireless network needs to interactively communicate with an IWF module. The IWF refers to a protocol conversion function employed for the interworking of circuit-switched domain data traffic between a wireless network and a non-wireless network, and the IWF module refers to a module implementing the IWF.

Specifically, an inter-network communication conversion device generally communicates with a wireless network via an Asynchronous Transfer Mode (ATM) interface, and communicates with a non-wireless network and an IWF module via Time Division Multiply (TDM) interfaces.

When a wireless network desires to send a data packet to a non-wireless network, the inter-network communication conversion device receives the data packet from the wireless network via the ATM interface between the inter-network communication conversion device and the wireless network, changes the bearer of the data packet from ATM to TDM. Next, the inter-network communication conversion device sends the data packet whose bearer has been changed to the IWF module via the TDM interface between the inter-network communication conversion device and the IWF module. The IWF module performs protocol processing on the data packet received from the inter-network communication conversion device, obtains an IWF payload from the data packet, modulates the obtained IWF payload and sends the modulated IWF payload to the non-wireless network via the TDM interface between the IWF module and the inter-network communication conversion device.

On the other hand, when a non-wireless network desires to send data to a wireless network, the inter-network communication conversion device receives the data from the non-wireless network via the TDM interface between the inter-network communication conversion device and the non-wireless network, and sends the received data to the module via the TDM interface between the inter-network communication conversion device and the IWF module. The IWF module demodulates the data from the inter-network communication conversion device, inserts the demodulated data as an IWF payload to a data packet supporting the TDM format, and sends the data packet containing the IWF payload to the inter-network communication conversion device via the TDM interface between the inter-network communication conversion device and the IWF module. The inter-network communication conversion device changes the bearer of the data packet from TDM to ATM, and sends the data packet whose bearer has been changed to the wireless network via the ATM interface.

As above, a bearer changing operation for the received data packet is needed on the inter-network communication conversion device to support normal communication between the wireless network and the non-wireless network. At present, the bearer changing operation is generally implemented by a Digital signal processor (DSP) configured in the inter-network communication conversion device. Also, the DSP needs to buffer the data packet prior to subsequent bearer changing operation, which leads to obvious communication delay and dramatically deteriorates communication quality between the wireless network and the non-wireless network. Furthermore, the DSP needs occupying a great deal of system resources when performing the bearer changing operations for a large amount of data packets, which increases the load of the inter-network communication conversion device, thereby considerably increasing the working cost and maintenance cost of the inter-network communication conversion device.

### SUMMARY OF THE INVENTION

Preferred embodiments of the present invention provide methods and systems as well as an inter-network communication conversion device and an IWF module for reducing communication delays and improving communication qualities between a wireless network and a non-wireless network.

In an embodiment of the present invention, a method for data interworking between networks includes:

receiving a data packet from a wireless network via a first Asynchronous Transfer Mode (ATM) interface and forwarding the received data packet to an Interworking Function (IWF) module via a second ATM interface; and

extracting, by the IWF module, an IWF user-plane payload from the received data packet and modulating the IWF user-plane payload to form a code stream, sending the code stream to a fixed communication network.

In another embodiment of the present invention, a method for data interworking between networks includes:

sending data from a fixed communication network to an IWF module;

processing including demodulating, by the IWF module, the received data, extracting an IWF user-plane payload from the demodulated data and converting the extracted IWF user-plane payload to a data packet supporting the ATM protocol; and

sending, by the IWF module, the converted data packet to a wireless network via an ATM interface.

In another embodiment of the present invention, a system for data interworking between networks includes:

an IWF module, and an inter-network communication conversion device connected with the IWF module;

the inter-network communication conversion device is configured to receive a data packet from a wireless network via a first ATM interface, and forward the received data packet to an IWF module via a second ATM interface; and

the IWF module is configured to extract an IWF user-plane payload from the received data packet and modulate the IWF user-plane payload to form a code stream, send the code stream to a fixed communication network.

In another embodiment of the present invention, a system for data interworking between networks includes:

an IWF module, and an inter-network communication conversion device connected with the IWF module; wherein

the inter-network communication conversion device is configured to send data from a fixed communication network to the IWF module;

the IWF module is further configured to process including demodulate the data from the inter-network communication conversion device, extract an IWF user-plane payload from the demodulated data, convert the extracted IWF user-plane payload to a data packet supporting the ATM protocol and send the converted data packet to a wireless network via an ATM interface.

Another embodiment of the present invention provides an inter-networking communication conversion device, configured to receive a data packet from a wireless network via a first ATM interface and send the data packet to an IWF module via a second ATM interface.

Another embodiment of the present invention provides an IWF module, configured to extract an IWF user-plane payload from a data packet received from an inter-network communication conversion device and modulate the IWF user-plane payload to form a code stream, and send the code stream to a fixed communication network.

As above, with one of the methods and systems for data interworking between networks in accordance with embodiments of the present invention, a data packet from a wireless network may be forwarded to an IWF module via an ATM interface. The IWF module extracts an IWF user-plane payload from the received data packet and modulates the IWF user-plane payload to form a code stream, sends the code stream to a fixed communication network.

With the other method and system for data interworking between networks in accordance with embodiments of the present invention, the IWF module may process including demodulating the data from the inter-network communication conversion device, extracting an IWF user-plane payload from the demodulated data, converting the extracted IWF user-plane payload to a data packet supporting the ATM protocol and sending the converted data packet to the wireless network via an ATM interface.

An inter-network communication conversion device in accordance with another embodiment of the present invention may be configured to receive a data packet from the wireless network via a first ATM interface, and forward the received data packet to an IWF module via a second ATM interface. An IWF module in accordance with another embodiment of the present invention may be configured to extract an IWF user-plane payload from a data packet received from the inter-network communication conversion device and modulate the IWF user-plane payload to form a code stream, and send the code stream to a fixed communication network.

As above, the methods and the systems for data inter-working as well as the inter-network communication conversion device and the IWF module provided in preferred embodiments of the present invention make it possible to decrease communication delay and dramatically improve communication qualities between a wireless network and a non-wireless network.

### BRIEF DESCRIPTION OF THE DRAWINGS

FIG. 1 is a schematic diagram illustrating the principle of data interworking between networks according to an embodiment of the present invention.

FIG. 2 is a flowchart illustrating data interworking between networks according to the principle shown in FIG. 1.

FIG. 3 is a schematic diagram illustrating the principle of data interworking between networks according to an embodiment of the present invention.

FIG. 4 is a schematic diagram illustrating the principle of data interworking between networks according to an embodiment of the present invention.

### DETAILED DESCRIPTION OF THE INVENTION

The present invention will be described hereinafter with reference to accompanying drawings and preferred embodiments.

A method and a system for data interworking between networks in accordance with one embodiment of the present invention may forward a data packet from a wireless network to an IWF module via an ATM interface. The IWF module extracts an IWF user-plane payload from the received data packet and modulates the IWF user-plane payload to form a code stream, and sends the code stream to a fixed communication network.

A method and a system for data interworking between networks in accordance with another embodiment of the present invention may process including demodulating the data from the inter-network communication conversion device, extracting an IWF user-plane payload from the demodulated data, converting the extracted IWF user-plane payload to a data pocket supporting the ATM protocol and sending the converted data packet to the wireless network via the ATM interface between the inter-network communication conversion device and the IWF module.

An inter-network communication conversion device provided by an embodiment of the present invention may be configured to receive a data packet from the wireless network via a first ATM interface, and forward the received data packet to an IWF module via a second ATM interface. An IWF module in accordance with an embodiment of the present invention may be configured to extract an IWF user-plane payload from a data packet received from the inter-network communication conversion device and modulate the IWF user-plane payload to form a code stream, and send the code stream to a fixed communication network.

Referring to FIG. 1, it shows a schematic diagram illustrating the principle of data interworking between networks according to an embodiment of the present invention. In FIG. 1, an inter-network communication conversion device 110 communicates with a network controller 120 via a first ATM interface, and communicates with an IWF module 130 via second ATM interface and a first TDM interface, and communicates with a fixed communication network 140 via a second TDM interface. The network controller 120 is a communication controller of the wireless network.

A data interworking system in the embodiment of the present invention includes the inter-network communication conversion device 110, the network controller 120, the IWF module 130.

In practical applications, the network controller 120 may communicatively interact with the fixed communication network 140 through the inter-network communication conversion device 110 and the IWF module 130.

When the network controller 120 has data to send to the fixed communication network 140, the inter-network communication conversion device 110 may first receive the data packet supporting the ATM protocol from the network controller 120 via the first ATM interface between the network controller 120 and the inter-network communication conversion device. Upon receiving the data packet from the network controller 120, the inter-network communication conversion device 110 forwards the data packet to the IWF module 130 via the second ATM interface between the inter-network communication conversion device 110 and the IWF module 130. Upon receiving the data packet from the inter-network communication conversion device 110, the IWF module 130 extracts the IWF user-plane payload from the data packet and modulates the IWF user-plane payload to form a code stream, and then sends the code stream to the fixed communication network 140 via the first TDM interface between the IWF module 130 and the inter-network communication conversion device 110 and the second TDM interface between the inter-network communication conversion device 110 and the fixed communication network 140. The fixed communication network 140 subsequently processes the code stream, including demodulation and the like.

Those skilled in the art should understand that, if it is desired that the data received by the fixed communication network 140 be an IP data packet, after modulating the data packet from the inter-network communication conversion device 110 to form a code stream, the IWF module 130 needs to pack the code stream to generate a data packet, convert the data packet to an IP data packet, and send the IP data packet to the inter-network communication conversion device 110 via an IP interface between the IWF module 130 and the inter-network communication conversion device 110. The inter-network communication conversion device 110 then sends the IP data packet to the fixed communication network 140 via an IP interface between the inter-network communication conversion device 110 and the fixed communication network 140. The fixed communication network 140 subsequently processes the IP data packet, including unpacking, demodulation and the like.

When the fixed communication network 140 has data to send to the network controller 120, the inter-network communication conversion device 110 may first receive the data from the fixed communication network 140.

If the data sent by the fixed communication network 140 is an IP data packet, the fixed communication network 140 may send the IP data packet to the inter-network communication conversion device 110 via the IP interface between the inter-network communication conversion device 110 and the fixed communication network 140. The inter-network communication conversion device 110 forwards the IP data packet to the IWF module 130 via the IP interface between the IWF module 130 and the inter-network communication conversion device 110. The IWF module 130 unpacks and demodulates the received IP data packet, extracts the IWF user-plane payload from the demodulated IP data packet, converts the extracted IWF user-plane payload to a data packet supporting the ATM protocol, and sends the converted data packet to the inter-network communication conversion device 10 via the ATM interface between the IWF module 130 and the inter-network communication conversion device 110. The inter-network communication conversion device 110 sends the received data packet to the network controller 120 via the ATM interface between the inter-network communication conversion device 110 and the network controller 120. The network controller 120 subsequently processes the received data packet, including forwarding.

If the data sent by the fixed communication network 140 is a code stream supporting the TDM protocol, the code stream may be received by the IWF module 130 via the second TDM interface between the fixed communication network 140 and the inter-network communication conversion device 110 and the first TDM interface between the inter-network communication conversion device 110 and the IWF module 130, and be demodulated by the IWF module 130. The IWF module 130 may also extract the IWF user-plane payload from the demodulated code stream, convert the extracted IWF user-plane payload to a data packet supporting the ATM protocol, and send the converted data packet to the inter-network communication conversion device 110 via the second ATM interface between the IWF module 130 and the inter-network communication conversion device 110. The inter-network communication conversion device 110 sends the received data packet to the network controller 120 via the first ATM interface between the inter-network communication conversion device 110 and the network controller 120. The network controller 120 subsequently processes the received data packet, including forwarding.

As above, the data interworking system including the inter-network communication conversion device 110, the network controller 120, the IWF module 130 and the fixed communication network 140 need not change bearer for the data packet involved in the data interworking. Thus the DSP need not buffer the data packet as required when changing the bearer, which greatly reduces communication delay and dramatically improves communication quality between the wireless network and the non-wireless network. Furthermore, system resources needed by the DSP when changing the bearer are reduced, which decreases the load of the inter-network communication conversion device, thereby decreasing the working cost and maintenance cost of the inter-network communication conversion device.

Noted that, in order to Support the data inter-working between the wireless network and the non-wireless network, a forwarding relationship based on an ATM interface should be established between the inter-network communication conversion device 10 and the IWF module 130, to enable the inter-network communication conversion device 110 and the IWF module 130 to subsequently forward the data packet according to the forwarding relationship to implement the data interworking between the wireless network and the non-wireless network.

Furthermore, when an IP data packet is inter-worked between the inter-network communication conversion device 110 and the fixed communication network 140, a forwarding relationship based on an IP interface should be established between the inter-network communication conversion device 110 and the IWF module 130, as well as between the inter-network communication conversion device 110 and fixed communication network 140, to enable the IWF module 130, the inter-network communication conversion device 110 and the fixed communication network 140 to subsequently forward the data packet according to the forwarding relationship to implement the data interworking between the wireless network and the non-wireless network.

Both the forwarding relationship based on the ATM interface and the forwarding relationship based on the IP interface may be established according to existing technologies, which will not be described herein.

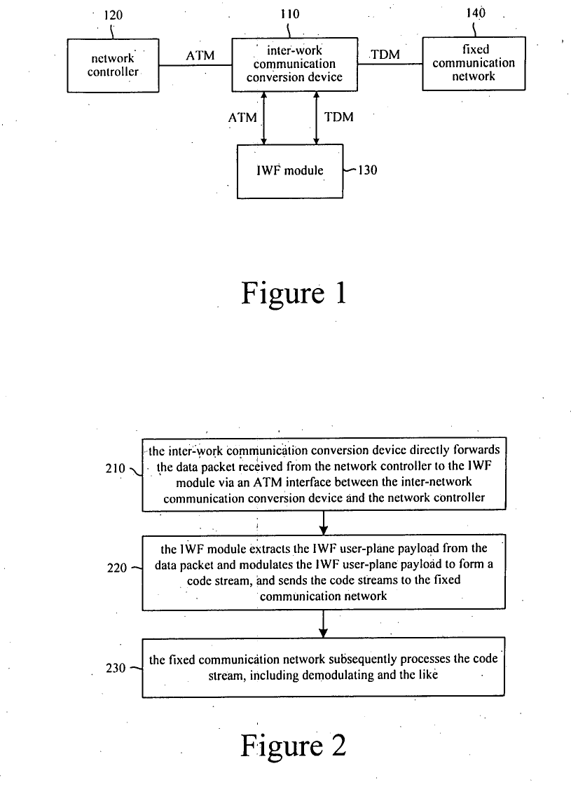

FIG. 2 shows a flowchart illustrating the principle of data interworking between networks as shown in FIG. 1, which includes the following steps.

Step 210: The inter-network communication conversion device receives a data packet from the network controller via an ATM interface between the inter-network communication conversion device and the network controller and forwards the received data packet to the IWF module via an ATM interface between the inter-network communication conversion device and the IWF module.

Step 220: The IWF module extracts the IWF user-plane payload from the data packet received from the inter-network communication conversion device and modulates the IWF user-plane payload to form a code stream, and sends the code stream to the fixed communication network via the TDM interface between the IWF module and the inter-network communication conversion device and the TDM interface between the inter-network communication conversion device and the fixed communication network.

Step 230: The fixed communication network subsequently processes the code stream, including demodulation and the like.

Those skilled in the art should understand that, if it is desired that the data received by the fixed communication network be an IP data packet, the IWF module needs to pack the code stream after modulating the data packet in step 220, convert the packed data packet to an IP data packet, and send the IP data packet to the inter-network communication conversion device via an IP interface between the IWF module and the inter-network communication conversion device. The inter-network communication conversion device then sends the IP data packet to the fixed communication network via an IP interface between the inter-network communication conversion device and the fixed communication network. The fixed communication network subsequently processes the IP data packet, including unpacking, demodulation and the like.

FIG. 2 only shows a flowchart of sending data by the network controller to the fixed communication network. A flowchart of sending data by the fixed communication network to the network controller is described as follows.

The inter-network communication conversion device receives a code stream supporting the TDM protocol from the fixed communication network, and sends the code stream to the IWF module via the TDM interface between the fixed communication network and the inter-network communication conversion device and TDM interface between the inter-network communication conversion device and the IWF module. The IWF module demodulates the code stream and extracts the IWF user-plane payload from the demodulated code stream, converts the extracted IWF user-plane payload to a data packet supporting the ATM protocol, and sends the converted data packet to the inter-network communication conversion device via the ATM interface between the IWF module and the inter-network communication conversion device. The inter-network communication conversion device sends the received data packet to the network controller via the ATM interface between the inter-network communication conversion device and the network controller. The network controller subsequently processes the received data packet, including forwarding.

Those skilled in the art should understand that, if the data sent from the fixed communication network to the inter-network communication conversion device is an IP data packet, the inter-network communication conversion device forwards the IP data packet from the fixed communication network to the IWF module via the IP interface between the fixed communication network and the IWF module, and the IWF module may first unpack and demodulate the IP data packet and then extract the IWF user-plane payload from the demodulated data.

The inter-network communication conversion device may be a Media Gateway (MGW) or a switch. The fixed communication network may be a PSTN, and the network controller used in the wireless network may be a Radio Network Controller (RNC).

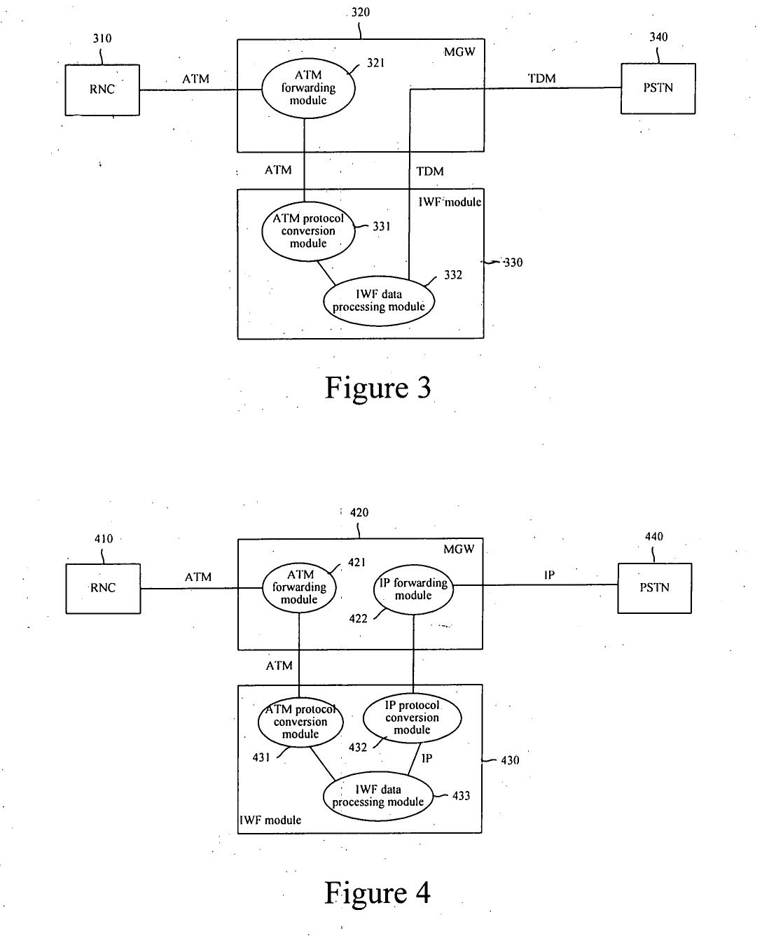

In practical applications, embodiments shown in FIG. 3 and FIG. 4 may illustrate the principles in FIG. 1 and the flowchart in FIG. 2.

Referring to FIG. 3, a schematic diagram illustrating the principle of data interworking between networks according to a preferred embodiment of the present invention is shown. In FIG. 3, an ATM forwarding module 321 in the MGW 320 communicates with an RNC 310 via a first ATM interface and communicates with an ATM protocol conversion module 331 in an IWF module 330 via a second ATM interface. An IWF data processing module 332 communicates with the ATM protocol conversion module 331, and communicates with a PSTN 340 via a first TDM interface between the IWF data processing module 332 and MGW 320 and a second TDM interface between the MGW 320 and the PSTN 340.

In practical applications, when the RNC 310 has data to send to the PSTN 340, the ATM forwarding module 321 may first receive the data packet supporting the ATM protocol from the RNC 310 via the first ATM interface between the RNC 310 and the ATM forwarding module 321. Upon receiving the data packet from the RNC 310, the ATM forwarding module 321 forwards the data packet to the ATM protocol conversion module 331 via the second ATM interface between the ATM forwarding module 321 and the ATM protocol conversion module 331. Upon receiving the data packet from the ATM forwarding module 321, the ATM protocol conversion module 331 extracts the IWF user-plane payload from the data packet and sends the IWF user-plane payload to the IWF data processing module 332. The IWF data processing module 332 modulates the IWF user-plane payload to form a code stream, and sends the code stream to the PSTN 340 via the First TDM interface between the IWF data processing module 332 and the MGW 320 and the second TDM interface between the MGW 320 and the PSTN 340. The PSTN 340 subsequently processes the code stream, including demodulation and the like.

When the PSTN 340 has a code stream supporting the TDM protocol to send to the RNC 310, the code stream may be received by the IWF data processing module 332 via the second TDM interface between the PSTN 340 and the MGW 320 and the First TDM interface between the MGW 320 and the IWF data processing module 332, and be demodulated by the IWF data processing module 332. The IWF data processing module 332 extracts the IWF user-plane payload from the demodulated code stream and sends the extracted IWF user-plane payload to the ATM protocol conversion module 331. The ATM protocol conversion module 331 converts the extracted IWF user-plane payload to a data packet supporting the ATM protocol, and sends the converted data packet to the ATM forwarding module 321 via the second ATM interface between the ATM protocol conversion module 331 and the ATM forwarding module 321. The ATM forwarding module 321 sends the received data packet to the RNC 310 via the first ATM interface between the ATM forwarding module 321 and the RNC 310. The RNC 310 subsequently processes the received data packet, including forwarding.

Referring to FIG. 4, a schematic diagram illustrating the principle of data interworking between networks according to another preferred embodiment of the present invention is shown. In FIG. 4, an ATM forwarding module 421 in the MGW 420 communicates with an RNC 410 via a first ATM interface and communicates with an ATM protocol conversion module 431 in an IWF module 430 via a second ATM interface. An IWF data processing module 433 in the IWF module 430 communicates with the ATM protocol conversion module 431, and communicates with an IP protocol conversion module 432 via a first IP interface. An IP forwarding module 422 in the MGW 420 communicates with the IP protocol conversion module 432 and with a PSTN 440 via a second IP interface.

In practical applications, when the RNC 410 has data to send to the PSTN 440, the ATM forwarding module 421 may first receive the data packet supporting the ATM protocol sent by the RNC 410 via the first ATM interface between the RNC 410 and the ATM forwarding module 421. Upon receiving the data packet from the RNC 410, the ATM forwarding module 421 forwards the data packet to the ATM protocol conversion module 431 via the second ATM interface between the ATM forwarding module 421 and the ATM protocol conversion module 431. Upon receiving the data packet from the ATM forwarding module 421, the ATM protocol conversion module 431 extracts the IWF user-plane payload from the data packet and sends the IWF user-plane payload to the IWF data processing module 433. The IWF data processing module 433 modulates the IWF user-plane payload to form a code stream, packs the code stream to generate a data packet, and sends data packet to the IP protocol conversion module 432 via the first IP interface between the IWF data processing module 433 and the IP protocol conversion module 432. The IP protocol conversion module 432 converts the received data packet to an IP data packet and sends the IP data packet to the IP forwarding module 422. The IP forwarding module 422 sends the received IP data packet to the PSTN 440 via the second IP interface between the IP forwarding module 422 and the PSTN 440. The PSTN 440 subsequently processes the IP data packet, including unpacking, demodulation and the like.

When the PSTN 440 has data to send to the RNC 410, the PSTN 440 may send an IP data packet to the IP forwarding module 422 via the second IP interface between the PSTN 440 and the IP forwarding module 422. The IP forwarding module 422 sends the IP data packet from the PSTN 440 to the IP protocol conversion module 432. The IP protocol conversion module 432 unpacks the IP data packet and sends the unpacked IP data packet to the IWF data processing module 433 via the first IP interface between the IP protocol conversion module 432 and the IWF data processing module 433. The IWF data processing module 433 demodulates the received data, extracts the IWF user-plane payload from the demodulated data and sends the extracted IWF user-plane payload to the ATM protocol conversion module 431. The ATM protocol conversion module 431 may convert the extracted IWF user-plane payload to a data packet supporting the ATM protocol, and send the converted data packet to the ATM forwarding module 421 via the second ATM interface between the ATM protocol conversion module 431 and the ATM forwarding module 421. The ATM forwarding module 421 sends the received data packet to the RNC 410 via the first ATM interface between the ATM forwarding module 421 and the RNC 410. The RNC 410 subsequently processes the received data packet, including forwarding.

The IWF module may be a traffic interworking device externally attached to the inter-network communication conversion device, or a function module integrated in the inter-network communication conversion device. In comparison, it is easier to integrate the IWF module in the inter-network communication conversion device, which only needs partial modifications within the inter-network communication conversion device while effectively improving integration and performance of the system.

Furthermore, both the ATM interfaces and the IP interfaces employed in the preferred embodiments of the invention may be set to a master-standby working mode. That is, the ATM interface and the IP interface may have two single-board interfaces, respectively, one of which is in a master state while the other is in a standby state. When a failure occurs on the master single-board interface, the standby single-board may switch to the master state. When the original master single-board recovers, the standby single-board may automatically switch back to the standby state, thereby effectively improving the reliability of communications.

As above, the methods and the systems for data interworking as well as the inter-network communication conversion device and the IWF module provided in the preferred embodiments of the present invention may decrease communication delay, dramatically improve communication qualities between a wireless network and a non-wireless network, thereby improving the satisfaction degree of subscribers.

The foregoing is only the preferred embodiments of this invention and is not intended to limit this invention. The invention is to cover all the modifications, variations and equivalent replacements within the spirit and scope of the disclosure as defined by the appended claims.

1. A method for data interworking between networks, comprising:
receiving a data packet from a wireless network via a first Asynchronous Transfer Mode (ATM) interface and forwarding the received data packet to an Interworking Function (IWF) module via a second ATM interface; and
extracting, by the IWF module, an IWF user-plane payload from the received data packet and modulating the IWF user-plane payload to form a code stream, sending the code stream to a fixed communication network.

2. (canceled)

3. The method of claim 1, further comprising:
after forming the code stream and before sending the code stream to a fixed communication network, packing the code stream to generate a data packet, converting the data packet to an IP data packet supporting the Internet Protocol (IP), and sending the IP data packet to the fixed communication network via an IP interface.

4. The method of claim 1, further comprising:
processing comprising demodulating, by the fixed communication network, the received code stream.

5. The method of claim 1, wherein the wireless network is a wireless access network.

6. (canceled)

7. The method of claim 1, further comprising:
receiving data from the fixed communication network by the IWF module;
processing including demodulating, by the IWF module, the received data, extracting an IWF user-plane payload from the demodulated data and converting the extracted IWF user-plane payload to a data packet supporting the ATM protocol; and
sending, by the IWF module, the converted data packet to the wireless network via the first and second ATM interfaces.

8. The method of claim 7, wherein the data from the fixed communication network is any one of a code stream supporting the TDM protocol and an IP data packet; and
the code stream supporting the TDM protocol is forwarded to the IWF module via the TDM interface;
and the IP data packet is forwarded to the IWF module via the IP interface.

9. (canceled)

10. A method for data interworking between networks, comprising:
receiving data from a fixed communication network by an Interworking Function (IWF) module;
processing comprising demodulating, by the IWF module, the received data, extracting an IWF user-plane payload from the demodulated data and converting the extracted IWF user-plane payload to a data packet supporting Asynchronous Transfer Mode (ATM) protocol; and
sending, by the IWF module, the converted data packet to the wireless network via an ATM interface.

11. The method of claim 10, wherein the data from the fixed communication network is any one of a code stream supporting Time Division Multiply (TDM) protocol and an IP data packet; and
the code stream supporting TDM protocol is forwarded to the IWF module via a TDM interface;
the IP data packet is forwarded to the IWF module via an Internet Protocol (IP) interface.

12. (canceled)

13. A system for data interworking between networks, comprising:
an Interworking Function (IWF) module, and an inter-network communication conversion device connected with the IWF module; wherein,
the inter-network communication conversion device is configured to receive a data packet from a wireless network via a first Asynchronous Transfer Mode (ATM) interface, and forward the received data packet to an IWF module via a second ATM interface; and
the IWF module is configured to extract an IWF user-plane payload from the received data packet and modulate the IWF user-plane payload to form a code stream, send the code stream to a fixed communication network.

14. The system of claim 13, wherein the inter-network communication conversion device comprises an ATM forwarding module for receiving and forwarding the data packet from the wireless network.

15. The system of claim 13, wherein the IWF module comprises an ATM protocol conversion module and an IWF data processing module connected with the ATM protocol conversion module;
the ATM protocol conversion module is configured to extract the IWF user-plane payload from the received data packet and send the IWF user-plane payload to the IWF data processing module; and
the IWF data processing module is configured to process comprising modulating the IWF user-plane payload received from the ATM protocol conversion module, and sending the modulated IWF user-plane payload to the fixed communication network.

16. The system of claim 13, wherein data is sent to the fixed communication network via a Time Division Multiply (TDM) interface.

17. The system of claim 13, wherein the IWF module further comprises an Internet Protocol (IP) protocol conversion module, and the inter-network communication conversion device further comprises an IP forwarding module;
the IP protocol conversion module is configured to convert the modulated IWF user-plane payload to an IP data packet supporting IP and send the IP data packet to the IP forwarding module; and
the IP forwarding module is configured to send the IP data packet from the IP protocol conversion module to the fixed communication network via a first IP interface.

18. The system of claim 13, wherein the wireless network is a wireless access network, the inter-network communication conversion device is connected with the wireless access network, and the wireless access network is configured to send a data packet to the inter-network communication conversion device.

19. The system of claim 13, wherein the fixed communication network is a Public Switched Telephone Network (PSTN).

20. The system of claim 13, wherein the inter-network communication conversion device is further configured to send the data from the fixed communication network to the IWF module; and
the IWF module is further configured to process comprising demodulating the data from the inter-network communication conversion device, extracting an IWF user-plane payload from the demodulated data, converting the extracted IWF user-plane payload to a data packet supporting the ATM protocol and sending the converted data packet to the wireless network via the first and second ATM interfaces.

21. The system of claim 20, wherein the inter-network communication conversion device comprises an ATM forwarding module and the IWF module comprises an ATM protocol conversion module and an IWF data processing module connected with the ATM protocol conversion module;
the IWF data processing module is configured to receive and demodulate the received data, extract the IWF user-plane payload from the demodulated data and send the IWF user-plane payload to the ATM protocol conversion module; and
the ATM protocol conversion module is configured to convert the IWF user-plane payload from the IWF data processing module to a data packet supporting the ATM protocol, and send the converted data packet to the ATM forwarding module; and
the ATM forwarding module is configured to send the data packet from the ATM protocol conversion module to the wireless network via the first ATM interface between the ATM forwarding module and the wireless network.

22. The system of claim 21, wherein the IWF module further comprises an IP protocol conversion module, and the inter-network communication conversion device further comprises an IP forwarding module;
the IP forwarding module is configured to send the IP data packet from the inter-network communication conversion device to the IP protocol conversion module, and
the IP protocol conversion module is configured to unpack the IP data packet received from the IP forwarding module and send the unpacked IP data packet to the IWF data processing module via a second IP interface.

23. A system for data interworking between networks, comprising:
an Interworking Function (IWF) module, and an inter-network communication conversion device connected with the IWF module; wherein
the inter-network communication conversion device is configured to send data from a fixed communication network to the IWF module;
the IWF module is configured to process comprising demodulating the data from the inter-network communication conversion device, extracting an IWF user-plane payload from the demodulated data, converting the extracted IWF user-plane payload to a data packet supporting Asynchronous Transfer Mode (ATM) protocol and sending the converted data packet to the wireless network via an ATM interface.

24. The system of claim 23, wherein the inter-network communication conversion device comprises an ATM forwarding module; the IWF module comprises an ATM protocol conversion module and an IWF data processing module connected with the ATM protocol conversion module;
the IWF data processing module is configured to receive and demodulate the received data, extracting the IWF user-plane payload from the demodulated data and send the extracted IWF user-plane payload to the ATM protocol conversion module; and
the ATM protocol conversion module is configured to convert the IWF user-plane payload received from the IWF data processing module to a data packet supporting the ATM protocol, and send the converted data packet to the ATM forwarding module; and
the ATM forwarding module is configured to send the data packet received from the ATM protocol conversion module to the wireless network via the ATM interface between the ATM forwarding module and the wireless network.

25. The system of claim 24, wherein the IWF module further comprises an Internet Protocol (IP) protocol conversion module, and the inter-network communication conversion device further comprises an IP forwarding module;
the IP forwarding module is configured to send an IP data packet from the inter-network communication conversion device to the IP protocol conversion module, and
the IP protocol conversion module is configured to unpack the IP data packet from the IP forwarding module and send the unpacked IP data packet to the IWF data processing module via an IP interface.

26. A device for data interworking between networks, configured to receive a data packet from a wireless network via a first Asynchronous Transfer Mode (ATM) interface and send the data packet to an Interworking Function (IWF) module via a second ATM interface.

27. The device of claim 26, comprising an ATM forwarding module for receiving and forwarding the data packet.

28. The device of claim 26, further configured to send data from a fixed communication network to the IWF module, and sending a data packet received by the ATM forwarding module to the wireless network via the first ATM interface.

29. An Interworking Function (IWF) module, configured to extract an IWF user-plane payload from a data packet received from an inter-network communication conversion device and modulate the IWF user-plane payload to form a code stream, and send the code stream to a fixed communication network.

30. The IWF module of claim 29, comprising:
an Asynchronous Transfer Mode (ATM) protocol conversion module and an IWF data processing module connected with the ATM protocol conversion module; wherein
the ATM protocol conversion module is configured to extract the IWF user-plane payload from the data packet and send the IWF user-plane payload to the IWF data processing module; and
the IWF data processing module is configured to process comprising modulating the IWF user-plane payload received from the ATM protocol conversion module, and sending the modulated IWF user-plane payload to the fixed communication network.

31. The IWF module of claim 29, further comprising: an IP protocol conversion module, configured to convert the modulated IWF user-plane payload to an IP data packet supporting IP and sending the IP data packet to the inter-network communication conversion device.

32. The IWF module of claim 29, further configured to process comprising demodulating data from the inter-network communication conversion device, extracting an IWF user-plane payload from the demodulated data, converting the extracted IWF user-plane payload to a data packet supporting the ATM protocol and sending the converted data packet to the wireless network via an ATM interface.

33. The method of claim 3, further comprising:
receiving data from the fixed communication network by the IWF module;
processing including demodulating, by the IWF module, the received data, extracting an IWF user-plane payload from the demodulated data and converting the extracted IWF user-plane payload to a data packet supporting the ATM protocol; and
sending, by the IWF module, the converted data packet to the wireless network via the first and second ATM interfaces.

34. The method of claim 6, further comprising:
receiving data from the fixed communication network by the IWF module;
processing including demodulating, by the IWF module, the received data, extracting an IWF user-plane payload from the demodulated data and converting the extracted IWF user-plane payload to a data packet supporting the ATM protocol; and
sending, by the IWF module, the converted data packet to the wireless network via the first and second ATM interfaces.

35. The system of claim 15, wherein data is sent to the fixed communication network via a TDM interface.

36. The system of claim 14, wherein the IWF module further comprises an Internet Protocol (IP) protocol conversion module, and the inter-network communication conversion device further comprises an IP forwarding module;
the IP protocol conversion module is configured to convert the modulated IWF user-plane payload to an IP data packet supporting IP and send the IP data packet to the IP forwarding module; and
the IP forwarding module is configured to send the IP data packet from the IP protocol conversion module to the fixed communication network via a first IP interface.

37. The system of claim 15, wherein the IWF module further comprises an Internet Protocol (IP) protocol conversion module, and the inter-network communication conversion device further comprises an IP forwarding module;
the IP protocol conversion module is configured to convert the modulated IWF user-plane payload to an IP data packet supporting IP and send the IP data packet to the IP forwarding module; and
the IP forwarding module is configured to send the IP data packet from the IP protocol conversion module to the fixed communication network via a first IP interface.

38. The system of claim 14, wherein the wireless network is a wireless access network, the inter-network communication conversion device is connected with the wireless access network, and the wireless access network is configured to send a data packet to the inter-network communication conversion device.

39. The system of claim 15, wherein the wireless network is a wireless access network, the inter-network communication conversion device is connected with the wireless access network, and the wireless access network is configured to send a data packet to the inter-network communication conversion device.

40. The device of claim 26, further configured to send data from a fixed communication network to the IWF module, and sending a data packet received by the ATM forwarding module to the wireless network via the first ATM interface.

41. The IWF module of claim 29, further comprising:
an IP protocol conversion module, configured to convert the modulated IWF user-plane payload to an IP data packet supporting IP and sending the IP data packet to the inter-network communication conversion device.
